(19) United States
(12) Patent Application Publication
(10) Pub. No.: US 2026/0178120 A1
(43) Pub. Date: Jun. 25, 2026

(54) DISPLAY DEVICE AND OPERATING METHOD THEREOF

(71) Applicant: SAMSUNG ELECTRONICS CO., LTD., Suwon-si (KR)

(72) Inventors: Changwoo LEE, Suwon-si (KR); Jia HA, Suwon-si (KR); Jiseon BAEK, Suwon-si (KR)

(73) Assignee: SAMSUNG ELECTRONICS CO., LTD., Suwon-si (KR)

(21) Appl. No.: 19/392,427

(22) Filed: Nov. 18, 2025

Related U.S. Application Data
(63) Continuation of application No. PCT/KR2025/018012, filed on Nov. 5, 2025.

(30) Foreign Application Priority Data
Dec. 19, 2024 (KR) 10-2024-0191709
Apr. 7, 2025 (KR) 10-2025-0044895

(51) Int. Cl. G06F 3/01; G06Q 30/0601; G06T 7/00

(52) U.S. Cl. CPC G06F 3/013; G06F 3/012; G06Q 30/0631; G06T 7/0012; G06T 2207/30201

(57) ABSTRACT

A display device includes a camera, a panel including at least a partial area that operates as a mirror or a display, memory storing one or more instructions, and at least one processor including processing circuitry, wherein the one or more instructions, when executed by the at least one processor individually or collectively, cause the display device to control the camera to capture an image of a user to obtain a user image, obtain information on a position of the user, obtain information on a gaze direction of the user, based on the user image, and control, based on the position information and the information on the gaze direction of the user, the panel such that the at least a partial area of the panel operates as the mirror or the display.

### CROSS-REFERENCE TO RELATED APPLICATIONS

This is a continuation application, under 35 U.S.C. §111(a), of International Application No. PCT/KR2025/018012, filed November 5, 2025, which claims priority under 35 U.S.C. §119 to Korean Patent Application No. 10-2024-0191709, filed December 19, 2024, and Korean Patent Application No. 10-2025-0044895, filed April 7, 2025, in the Korean Intellectual Property Office, the disclosures of which are incorporated herein in their entireties by reference.

### TECHNICAL FIELD

The disclosure relates to a display device capable of performing a mirror function and/or a display function to display information and an operating method thereof.

### BACKGROUND ART

Advances in modern display technology have changed the role of existing display devices from simply providing information to providing more diverse functions and user experience. Early display devices were limited to displaying content on a fixed screen, but with the advent of innovative technologies such as transparent displays, translucent organic light-emitting diodes (OLEDs), and electrochromic displays, the uses of display devices have expanded significantly.

In particular, translucent display technology has enabled a combination of an ordinary mirror with a display device, allowing a signal device to perform two roles. A smart mirror may convert an existing mirror into a display device or use a display device as a mirror, thus concurrently providing both intuitiveness and practicality in displaying information. Furthermore, sensor technology and network connectivity built into a display device provide a foundation for implementing multi-functional display devices that have user interaction and data processing capabilities in addition to providing information.

Consequently, these technological advances linked to display devices have presented expansion possibilities across a variety of application fields, including providing customized information in various user environments, smart home integration, and healthcare monitoring, beyond simply providing visual information.

### Disclosure

### Technical Solution

A display device according to various embodiments of the disclosure may include a camera, a panel including at least a partial area that is operable as a mirror and operable as a display, at least one processor including processing circuitry, and memory storing one or more instructions that, when executed by the at least one processor individually or collectively, may cause the display device to control the camera to capture an image of a user to obtain a user image, obtain information on the position of the user, obtain information on a gaze direction of the user based on the user image, and control, based on the information on the position of the user and the information on the gaze direction of the user, the panel such that the at least a partial area of the panel operates as at least one of the mirror and the display.

An operating method of a display device including a panel having at least a partial area that is operable as a mirror and operable as a display, according to various embodiments of the disclosure, may include capturing an image of a user to obtain a user image, obtaining information on the position of the user, obtaining information on the gaze direction of the user, based on the user image, and operating the at least a partial area of the panel as at least one of the mirror and the display based on the information on the position of the user and the information on the gaze direction of the user.

### DESCRIPTION OF DRAWINGS

FIG. 1 is a diagram of a display device according to an embodiment of the disclosure.

FIG. 2 is a flowchart showing an operating method of a display device, according to an embodiment of the disclosure.

FIG. 3 is a flowchart showing a method of operating, by a display device, a panel as a mirror or a display, according to an embodiment of the disclosure.

FIG. 4 is a diagram showing an example in which a display device according to an embodiment of the disclosure operates a panel as a display.

FIG. 5 is a diagram showing an example in which a display device according to an embodiment of the disclosure operates a panel as a display.

FIG. 6 is a diagram showing an example in which a display device according to an embodiment of the disclosure operates a panel as a mirror.

FIG. 7 is a diagram showing an operation when a display device according to an embodiment of the disclosure recognizes a plurality of users.

FIG. 8 is a diagram showing an example in which a display device according to an embodiment of the disclosure operates a partial area of a panel as a mirror.

FIG. 9 is a diagram showing an example in which a display device according to an embodiment of the disclosure operates at least a partial area of a panel as a display or a mirror.

FIG. 10 is a diagram showing an operation in which a display device according to an embodiment of the disclosure analyzes and displays a user's facial condition.

FIG. 11 is a diagram showing an example in which a display device according to an embodiment of the disclosure provides recommendation information based on the facial condition analysis.

FIG. 12 is a block diagram of a display device according to an embodiment of the disclosure.

FIG. 13 is a block diagram of a display device according to an embodiment of the disclosure.

### MODE FOR INVENTION

The terms used in the disclosure are briefly described and the disclosure is described in detail.

The terms used in the disclosure have been selected from currently widely used general terms in consideration of the functions in the disclosure. However, the terms may vary according to the intention of one of ordinary skill in the art, case precedents, and the advent of new technologies. Also, for special cases, meanings of the terms selected by the applicant are described in detail in the description section. Accordingly, the terms used in the disclosure are defined based on their meanings in relation to the contents discussed throughout the specification, not by their simple meanings.

When a part may "include" a certain component, unless specified otherwise, it may not be construed to exclude another component but may be construed to further include other components. Terms such as "... portion," "... unit," "... module," and "... block" stated in the disclosure may signify a unit to process at least one function or operation and the unit may be embodied by hardware such, software, or a combination of hardware and software.

Expressions such as “at least one of A and B”, "at least one of A, and B", "at least one of A or B", "at least one of A, or B", and similar expressions, as used herein, includes any of the following: A, B, A and B. Similarly, expressions such as "at least one of A, B and C', “at least one of A, B, and C”, "at least one of A, B or C", "at least one of A, B, or C", as used herein, includes any of the following: A, B, C, A and B, A and C, B and C, A and B and C.

The embodiment of the disclosure of the disclosure is described with reference to the accompanying drawings so that one skilled in the art to which the disclosure pertains can easily work the disclosure. However, the disclosure may be implemented in various forms and are not limited to the embodiment of the disclosures described below. In the drawings, a part that is not related to a description is omitted to clearly describe the disclosure and, throughout the specification, similar parts are referenced with similar reference numerals.

In the embodiment of the disclosures of the specification, the term "user" refers to a person who controls a system, a function, or an operation, and may include a developer, an administrator, or an installation engineer.

Furthermore, in the embodiment of the disclosures of the specification, an "image" or a "picture" may represent a still image, a moving image composed of a plurality of consecutive still images (or frames), or a video.

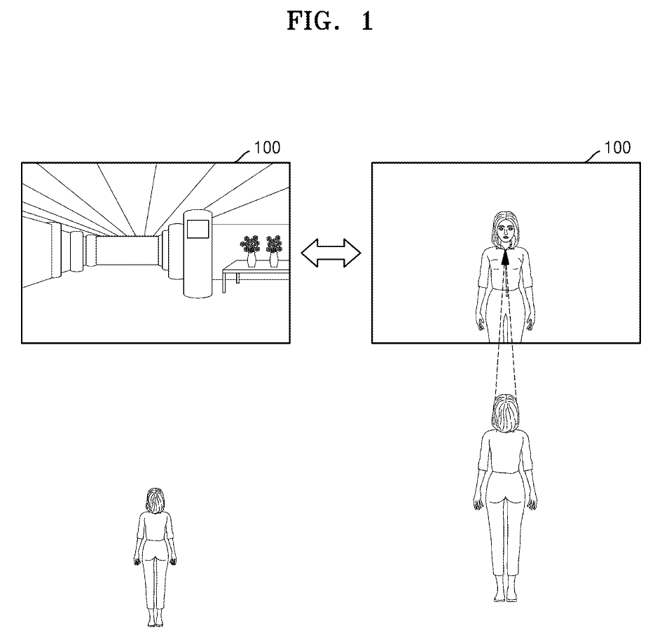

FIG. 1 is a diagram of a display device 100 according to an embodiment of the disclosure.

Referring to FIG. 1, the display device 100 according to an embodiment of the disclosure may have a mirror function and a display function. For example, the display device 100 may include a panel that operates as a mirror or a display. The panel may be a device that displays information or an image, when necessary, while appearing as an ordinary mirror.

The panel according to an embodiment of the disclosure may be switched between a mirror mode and a display mode so as to operate in a mirror mode or a display mode, respectively. When the panel operates as a mirror (mirror mode), the panel reflects light from an external light source so as to show a user's appearance. Furthermore, when the panel operates as a display (display mode), the panel may provide various pieces of visual information to a user.

The panel according to an embodiment of the disclosure may be formed as one integral module or in a structure in which a plurality of layers are stacked. For example, the panel may include both a mirror layer and a display layer.

The mirror layer according to an embodiment of the disclosure may be a layer that reflects external light so as to operate as an ordinary mirror. The mirror layer may include a half mirror or a switchable mirror. The half mirror is a mirror that partially reflects and partially transmits light, which may be referred to as a translucent mirror. Furthermore, the switchable mirror may have transparency or reflectance that varies in response to an external electrical signal. For example, the switchable mirror may be switched to a mirror that reflects light when power is off, and to appear as transparent glass when power is on.

In the panel according to an embodiment of the disclosure, the display layer is arranged at the rear side of the mirror layer. The display layer may include an organic light-emitting diode (OLED), a micro-LED, or a transparent display, and display information, an image, or a graphical user interface (GUI).

The display device 100 according to an embodiment of the disclosure may be referred as a smart mirror, a magic mirror, an interactive mirror, or a smart display mirror, but the disclosure is not limited thereto.

The display device 100 according to an embodiment of the disclosure may be used for a mirror installed in a bathroom, a mirror used in a fitness center or home exercise room, a mirror used on a dressing table or in a beauty salon, or a digital signage, but the disclosure is not limited thereto.

The display device 100 according to an embodiment of the disclosure may include various sensors and recognize a user around the display device 100 by using the sensors. For example, the display device 100 may recognize a user existing within a preset range from the display device 100 by using a camera, an infrared sensor, a heat sensor, an ultrasound sensor, or a proximity sensor.

The display device 100 according to an embodiment of the disclosure, when recognizing a user, may obtain position information of the recognized user. For example, the display device 100 may capture an image of a user by using a camera to obtain a relative position of the user with respect to the display device 100 or a distance between the display device 100 and the user. However, the disclosure is not limited thereto.

Referring to FIG. 1, the display device 100 according to an embodiment of the disclosure may control the panel to perform a display function when the distance between the display device 100 and a user is greater than or equal to a preset distance. For example, the display device 100 may operate the panel included in the display device 100 in a display mode to display various pieces of information. However, the disclosure is not limited thereto.

Furthermore, the display device 100 according to an embodiment of the disclosure may obtain a gaze direction of a user based on a user image captured of a user. For example, the display device 100 may obtain a gaze direction of a user by using an eye tracking function.

Referring to FIG. 1, the display device 100 according to an embodiment of the disclosure may control the panel to perform a mirror function when the distance between the display device 100 and a user is less than the preset distance and the gaze direction of the user is directed toward a user reflected from the panel. For example, the display device 100 may operate the panel included in the display device 100 in a mirror mode to provide an image of an object reflected from the panel. However, the disclosure is not limited thereto.

The display device 100 according to an embodiment of the disclosure may operate the panel in a mirror mode or a display mode based on the information on the position of a user and information on the gaze direction of the user. Accordingly, the user's convenience may be improved by automatically switching to a mirror or a display by identifying the user's intention without additional commands or input from the user.

A method in which the display device 100 according to an embodiment of the disclosure operates the panel as a mirror or a display is described below in detail with reference to the drawings.

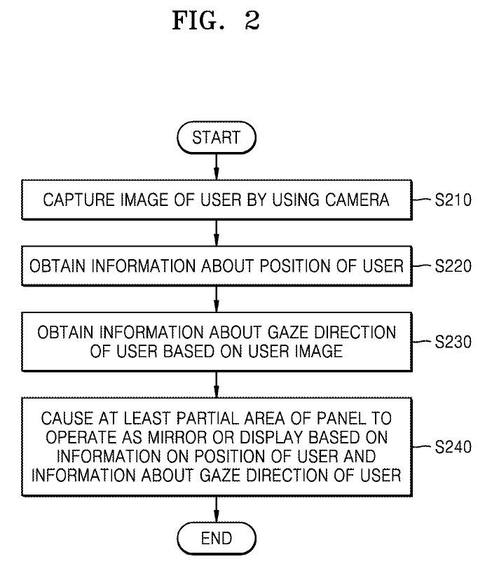

FIG. 2 is a flowchart showing an operating method of a display device, according to an embodiment of the disclosure.

Referring to FIG. 2, the display device 100 according to an embodiment of the disclosure may capture an image of a user by using a camera (S210).

The display device 100 according to an embodiment of the disclosure may include at least one camera. The at least one camera may be built in the display device 100 or provided separately to be connected to the display device 100. The at least one camera may be installed on the front side or lateral side of the display device 100, but the disclosure is not limited thereto.

When a user is recognized in front of the display device 100, the display device 100 may capture an image of the recognized user. Furthermore, when a plurality of users are recognized, the display device 100 may capture an image of a user who is nearest to the display device 100 or the camera among the plurality of users. However, the disclosure is not limited thereto.

The display device 100 according to an embodiment of the disclosure may obtain information on the position of a user (S220).

For example, the display device 100 according to an embodiment of the disclosure may obtain information on the position of a user by using a camera, an ultrasound sensor, an infrared sensor, or an RF-based sensor. The display device 100 based on sensor data collected from various sensors, may calculate the distance between the display device 100 and a user. Furthermore, the display device 100 may calculate a direction or an angle at which the user is positioned with respect to the display device 100, based on the sensor data. However, the disclosure is not limited thereto.

The display device 100 according to an embodiment of the disclosure may obtain information on the gaze direction of a user, based on the user image captured in operation S210 (S230).

The display device 100 according to an embodiment of the disclosure may track user′s gaze based on the user image. The display device 100 may recognize a user's face from the user image captured of a user. For example, the display device 100 may identify the outline of the face and key feature points, such as eyes, nose, or mouth, from the user image, by using a deep learning-based face recognition algorithm or a feature point-based algorithm. The display device 100, when a face is recognized, may delicately and accurately extract an eye area within a face area.

The display device 100 may identify positions of iris and pupil within the eye area and calculate a gaze direction in which a user views, based on the positions of the iris and the pupil. Furthermore, the display device 100 may calculate a relative position relationship between the center point of the pupil and an eye outline, thereby calculating the gaze direction of a user. The display device 100 may calculate a user's head direction by using the key feature points (feature points, such as eye, nose, or mouth) of a face, and when calculating the gaze direction, the display device 100 may use information on the user's head direction. However, the disclosure is not limited thereto.

The display device 100 according to an embodiment of the disclosure may operate at least a partial area of the panel as a mirror or a display, based on the information on the position of a user and information on the gaze direction of the user (S240).

For example, when the distance between the display device 100 and a user is greater than or equal to the preset distance, the display device 100 may operate the panel included in the display device 100 as a display, thereby displaying various pieces of information. Alternatively, when the distance between the display device 100 and a user is less than the preset distance, and the gaze direction of the user is directed toward a user reflected from the panel, the display device 100 may operate at least a partial area of the panel as a mirror. However, the disclosure is not limited thereto.

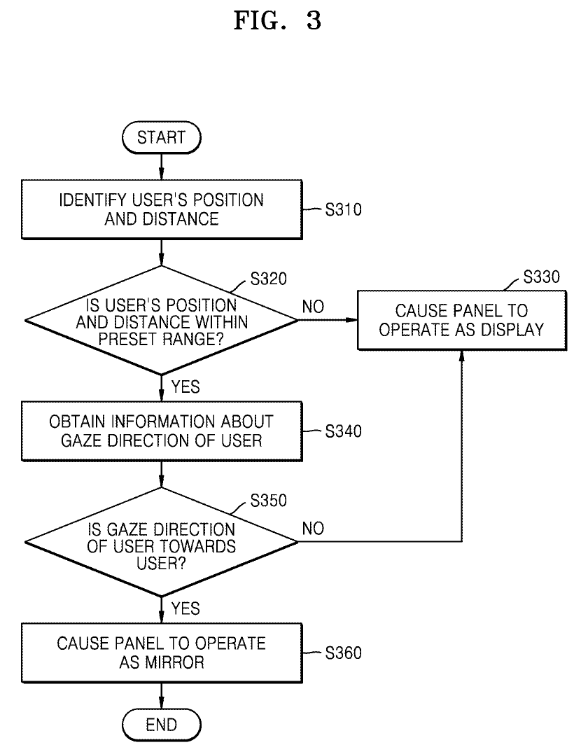

FIG. 3 is a flowchart showing a method of operating, by a display device, a panel as a mirror or a display, according to an embodiment of the disclosure.

Referring to FIG. 3, the display device 100 according to an embodiment of the disclosure may identify a user's position and a distance (S310).

For example, the display device 100 according to an embodiment of the disclosure may obtain information on the position of a user by using a camera, an ultrasound sensor, an infrared sensor, or an RF-based sensor. The display device 100 may calculate the distance between the display device 100 and a user, based on sensor data collected from various sensors.

Furthermore, the display device 100 may calculate a direction or an angle at which the user is positioned with respect to the display device 100, based on the sensor data. However, the disclosure is not limited thereto.

The display device 100 according to an embodiment of the disclosure may identify whether the user's position and distance is within a preset range (S320).

For example, the display device 100 may identify whether the distance between the display device 100 and a user is less than the preset distance, and identify whether the direction or angle at which the user is positioned with respect to the display device 100 is within a preset direction and angle range. However, the disclosure is not limited thereto.

When the user's position and distance is not within the preset range, the display device 100 according to an embodiment of the disclosure may operate the panel as a display, thereby displaying various pieces of information (S330).

When the user's position and distance is within the preset range, the display device 100 according to an embodiment of the disclosure may obtain information on the gaze direction of a user (S340).

For example, the display device 100 may recognize a user′s face from an image captured of a user. The display device 100 may extract an eye area within a face area and calculate the gaze direction of a user based on specific objects (e.g., iris, pupil etc.) in the eye area. The display device 100 may calculate a user's head direction by using the key feature points (feature points, such as eye, nose, or mouth) within the face area, and calculate the gaze direction by using the head direction information. However, the disclosure is not limited thereto.

The display device 100 according to an embodiment of the disclosure may identify whether the gaze direction of a user is directed toward the image of the user reflected from the panel (S350).

When the gaze direction of a user is not directed toward the image of the user reflected from the panel, the display device 100 may operate the panel as a display, thereby displaying various pieces of information (S330).

When the gaze direction of a user is directed toward the image of the user reflected from the panel, the display device 100 may operate the panel as a mirror (S360).

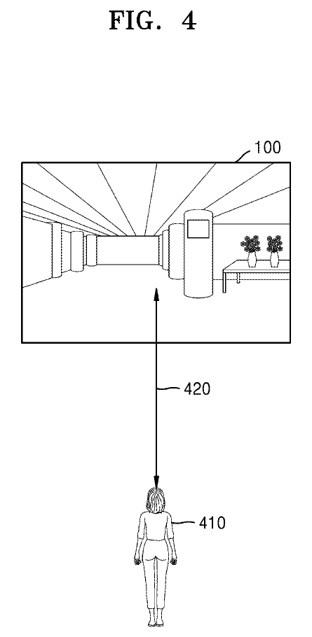

FIG. 4 is a diagram showing an example in which a display device according to an embodiment of the disclosure operates a panel as a display.

Referring to FIG. 4, the display device 100 according to an embodiment of the disclosure may recognize a user existing around the display device 100 by using various sensors, and obtain position information of the user 410 that is recognized. For example, the position information of the user 410 may include a distance between the display device 100 and the user. The display device 100 may measure the distance between the display device 100 and the user by using a distance sensor. The distance sensor may include an ultrasound sensor, an infrared sensor, a LiDAR sensor, a stereo camera, a ToF camera, or a structured light sensor. However, the disclosure is not limited thereto.

When the distance between the display device 100 and the user 410 is greater than or equal to a preset distance, the display device 100 may operate the panel of the display device 100 as a display.

For example, as illustrated in FIG. 4, a first distance 420 between the display device 100 and the user 410 is greater than or equal to the preset distance, the display device 100 may operate the panel as a display, thereby displaying various pieces of information.

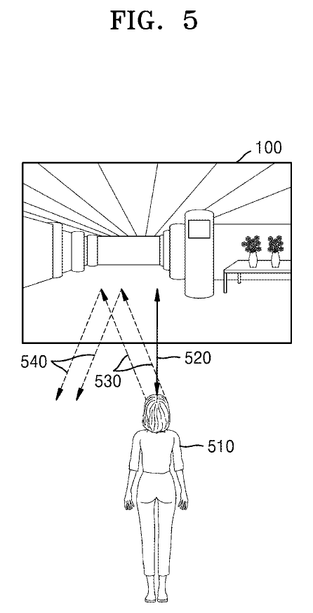

FIG. 5 is a diagram showing an example in which a display device according to an embodiment of the disclosure operates a panel as a display.

Referring to FIG. 5, the display device 100 according to an embodiment of the disclosure may recognize a user existing around the display device 100 and obtain the information on the position of a recognized user. For example, the information on the position of a user may include the distance between the display device 100 and the user. As the operations of recognizing a user and measuring a distance, which are performed by the display device 100, are described in detail with reference to FIG. 4, the same description is omitted.

When a second distance 520 between the display device 100 and a user 510 is less than a preset distance, the display device 100 may capture an image of a user by using a camera to obtain a user image.

The display device 100 may recognize the face of the user 510 from the user image. The display device 100 may extract an eye area within an area of the recognized user′s face, and calculate a gaze direction 530 of the user 510 based on the positions of the iris and the pupil of the user 510 included in the eye area.

Furthermore, the display device 100 may calculate a head direction of the user 510 in the user image, and calculate the gaze direction 530 of the user 510 based on the head direction of the user 510.

The display device 100 may identify whether the gaze direction 530 of the user 510 is directed toward the image of the user 510 reflected from the panel. Alternatively, the display device 100 may identify whether a direction 540 in which the gaze direction 530 of the user 510 is reflected from the panel is directed toward the user 510.

For example, as illustrated in FIG. 5, the display device 100 may calculate the direction 540 in which the gaze direction 530 of the user 510 is reflected from the panel. The display device 100 may identify whether the direction 540 after reflection is directed toward the user 510, and when the direction 540 after reflection is not directed toward the user 510, the display device 100 may operate the panel as a display, thereby displaying various pieces of information.

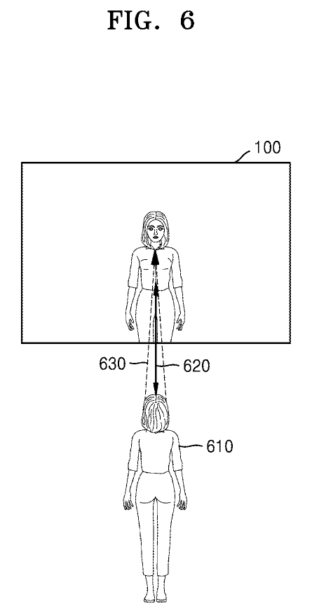

FIG. 6 is a diagram showing an example in which a display device according to an embodiment of the disclosure operates a panel as a mirror.

Referring to FIG. 6, the display device 100 according to an embodiment of the disclosure may recognize a user existing around the display device 100 and obtain the information on the position of a recognized user. For example, the information on the position of a user may include the distance between the display device 100 and the user. As the operations of recognizing a user and measuring a distance, which are performed by the display device 100, are described in detail with reference to FIG. 4, the same description is omitted.

When a third distance 620 between the display device 100 and a user 610 is less than a preset distance, the display device 100 may capture an image of the user 610 by using a camera to obtain a user image.

The display device 100 may recognize the face of the user 610 from the user image. The display device 100 may extract an eye area within an area of the recognized user′s face, based on the positions of the iris and the pupil of the user 610 included in the eye area, and calculate a gaze direction 630 of the user 610.

Furthermore, the display device 100 may calculate a user′s head direction in the user image, and calculate the gaze direction 630 of the user 610 based on the user′s head direction.

The display device 100 may identify whether the gaze direction 630 of the user is directed toward the image of the user 610 reflected from the panel. Alternatively, the display device 100 may identify whether the gaze direction of the user 610 reflected from the panel is directed toward the user 610.

For example, as illustrated in FIG. 6, when the gaze direction 630 of the user 610 is directed toward the image of the user 610 reflected from the panel, the display device 100 may operate the panel as a mirror.

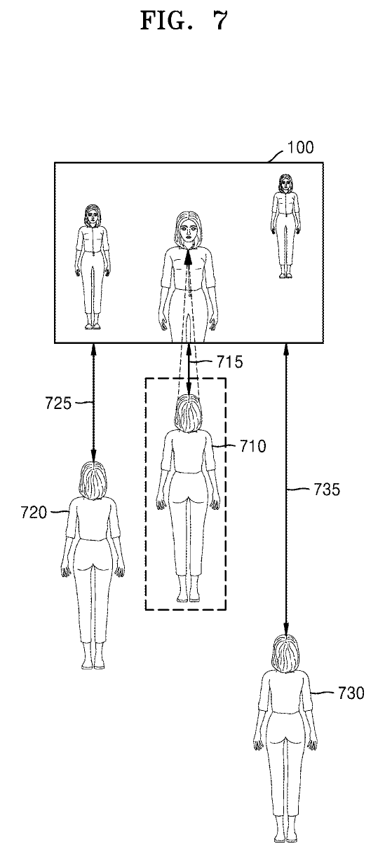

FIG. 7 is a diagram showing an operation when a display device according to an embodiment of the disclosure recognizes a plurality of users.

Referring to FIG. 7, the display device 100 according to an embodiment of the disclosure may recognize a plurality of users existing around the display device 100.

The display device 100 according to an embodiment of the disclosure may determine whether to operate the panel as a display or as a mirror, based on position information and gaze information of a user positioned at the nearest distance among the plurality of users who are recognized.

The display device 100 may obtain a distance between the display device 100 and each of the plurality of users who are recognized. For example, the display device 100 may measure the distance between the display device 100 and each of the plurality of users by using a distance sensor.

As illustrated in FIG. 7, the display device 100 may recognize a first user 710, a second user 720, and a third user 730, and measure a first distance 715 between the first user 710 and the display device 100, a second distance 725 between the second user 720 and the display device 100, and a third distance 735 between the third user 730 and the display device 100.

The display device 100 may operate the panel as a display or a mirror, based on the first user 710 who is positioned at the first distance 715 that is the nearest distance among the first distance 715, the second distance 725, and the third distance 735.

For example, the display device 100 may check whether the distance (the first distance 715) between the first user 710 and the display device 100 is greater than or equal to a preset distance. When the first distance 715 is greater than or equal to the preset distance, the display device 100 may operate the panel as a display.

In contrast, when the first distance 715 is less than the preset distance, the display device 100 may capture an image of the first user 710 by using a camera to obtain a user image. The display device 100 may recognize the face of the first user 710 in the user image. The display device 100 may detect an eye area within a face area of the first user 710 and calculate a gaze direction of the first user 710 based on a specific object (e.g., pupil or iris) included in the eye area. Furthermore, the display device 100 may calculate a head direction of the first user 710 in the user image and calculate the gaze direction of the first user 710 based on the head direction.

The display device 100 may identify whether the gaze direction of the first user 710 is directed toward an image of the first user 710 reflected from the panel. Alternatively, the display device 100 may identify whether the gaze direction of the first user 710 reflected from the panel is directed toward the first user 710.

For example, when the gaze direction of the first user 710 reflected from the panel is directed toward the second user 720 or the third user 730, not the first user 710, the display device 100 may operate the panel of the display device 100 as a display.

In contrast, as illustrated in FIG. 7, when the gaze direction of the first user 710 is directed toward the image of the first user 710 reflected from the panel, the display device 100 may operate the panel as a mirror.

Although FIG. 7 illustrates an example in which, when a plurality of users are recognized, the operation mode of the panel is determined based on a user positioned at the nearest distance from the display device 100, the disclosure is not limited thereto.

When a plurality of users are recognized, the display device 100 according to an embodiment of the disclosure may determine whether to operate the panel as a display or as a mirror, based on the number of users positioned closer than the preset distance to the display device 100, the ratio of users positioned closer than the preset distance to the number of recognized users, or the size of the panel of the display device. However, the disclosure is not limited thereto.

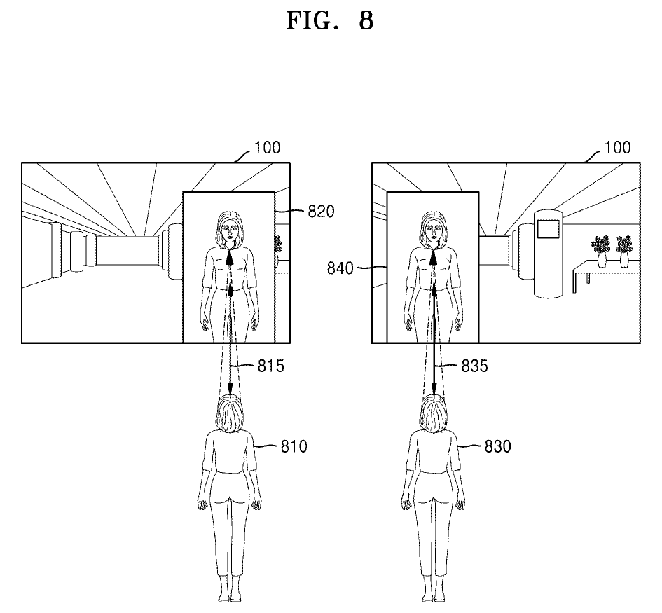

FIG. 8 is a diagram showing an example in which a display device according to an embodiment of the disclosure operates a partial area of a panel as a mirror.

Referring to FIG. 8, the display device 100 according to an embodiment of the disclosure may recognize a user existing around the display device 100. The display device 100 according to an embodiment of the disclosure may determine whether to operate the panel as a display or a mirror, based on position information and gaze information of the recognized user.

When the panel is determined to operate as a mirror, the display device 100 according to an embodiment of the disclosure may operate only a part of the panel as a mirror according to the position of the user.

For example, when a first user 810 is positioned at a first position, a distance (a first distance 815) between the first user 810 and the display device 100 is less than a preset distance, and the gaze direction of the first user 810 is directed toward an image of the first user 810 reflected from the panel, the display device 100 may operate a first area 820 of the panel corresponding to the first position as a mirror. The display device 100 may operate the other area of the panel except the first area 820 as a display.

The display device 100 may operate the first area 820 of the panel as a mirror by increasing the reflectance of the first area 820 and decreasing transmittance thereof. However, the disclosure is not limited thereto.

Alternatively, when a second user 830 is positioned at a second position, a distance (a second distance 835) between the second user 830 and the display device 100 is less than a preset distance, the gaze direction of the second user 830 is directed toward an image of the second user 830 reflected from the panel, the display device 100 may operate a second area 840 of the panel corresponding to the second position as a mirror. The display device 100 may operate the other area of the panel except the second area 840 as a display.

The display device 100 may operate the second area 840 of the panel as a mirror by increasing the reflectance of the second area 840 and decreasing transmittance thereof. However, the disclosure is not limited thereto.

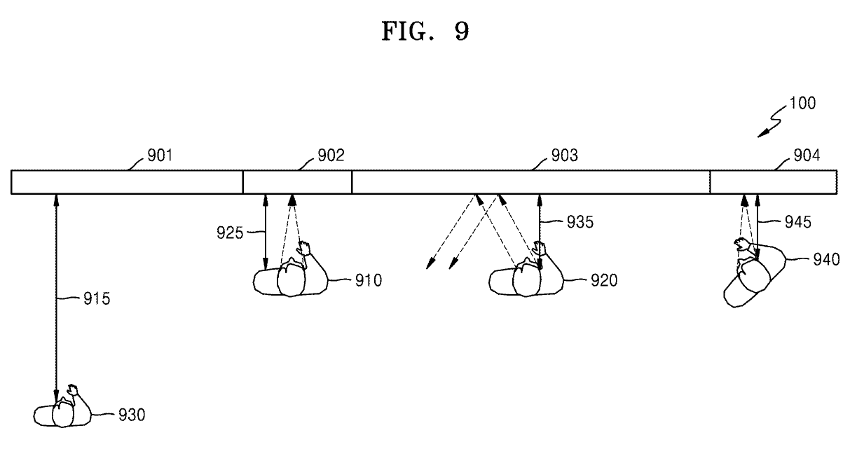

FIG. 9 is a diagram showing an example in which a display device according to an embodiment of the disclosure operates at least a partial area of a panel as a display or a mirror.

Referring to FIG. 9, the display device 100 according to an embodiment of the disclosure may include a display device including a large panel. The large panel according to an embodiment of the disclosure may be divided into a plurality of areas, and the size and the shape of each of the plurality of areas may be preset. For example, the plurality of areas may include a first area 901, a second area 902, a third area 903, and a fourth area 904, but the disclosure is not limited thereto.

Furthermore, the display device 100 may change the size and the shape of each of the plurality of areas, as necessary. For example, in the display device 100, the plurality of areas may be divided to correspond to the positions of the plurality of users who are recognized.

As illustrated in FIG. 9, a plurality of users may be located around the display device 100. The display device 100 may recognize a plurality of users located around the display device 100. For example, the display device 100 may recognize a first user 910, a second user 920, a third user 930, and a fourth user 940.

The display device 100 may operate the first area 901 of the plurality of areas included in the panel as a mirror or a display, based on the position information of the first user 910 and the gaze direction information of the first user 910. The first area 901 may be an area corresponding to the position of the first user 910 and positioned in front of the first user 910.

For example, the display device 100 may obtain a first distance 915 between the first user 910 and the display device 100 or the panel, and when the first distance 915 is greater than or equal to a preset distance, the display device 100 may operate the first area 901 as a display.

Furthermore, the display device 100 may operate the second area 902 of the plurality of areas included in the panel as a mirror or a display, based on the position information of the second user 920 and the gaze direction information of the second user 920. The second area 902 may be an area corresponding to the position of the second user 920 and positioned in front of the second user 920.

For example, the display device 100 may obtain a second distance 925 between the second user 920 and the display device 100 or the panel, and when the second distance 925 is less than the preset distance, the display device 100 may obtain information on the gaze direction of the second user 920.

When the gaze direction of the second user 920 is directed toward an image of the second user 920 reflected from the panel, the display device 100 may operate the second area 902 as a mirror.

Furthermore, the display device 100 may operate the third area 903 of the plurality of areas included in the panel as a mirror or a display, based on the position information of the third user 930 and the gaze direction information of the third user 930. The third area 903 may be an area corresponding to the position of the third user 930 and positioned in front of the third user 930.

For example, the display device 100 may obtain a third distance 935 between the third user 930 and the display device 100 or the panel, and when the third distance 935 is less than the preset distance, the display device 100 may obtain the gaze direction information of the third user 930.

When the gaze direction of the third user 930 reflected from the panel is not directed toward the third user 930, the display device 100 may operate the third area 903 as a display.

Furthermore, the display device 100 may operate the fourth area 904 of the plurality of areas included in the panel as a mirror or a display, based on the position information of the fourth user 940 and the gaze direction information of the fourth user 940. The fourth area 904 may be an area corresponding to the position of the fourth user 940 and positioned in front of the fourth user 940.

For example, the display device 100 may obtain a fourth distance 945 between the fourth user 940 and the display device 100 or the panel, and when the fourth distance 945 is less than the preset distance, the display device 100 may obtain the gaze direction information of the fourth user 940.

When the head direction of the fourth user 940 is not directed toward the fourth area 904 but the gaze direction of the fourth user 940 is directed toward an image of the fourth user 940 reflected from the panel, the display device 100 may operate the fourth area 904 as a mirror. However, the disclosure is not limited thereto.

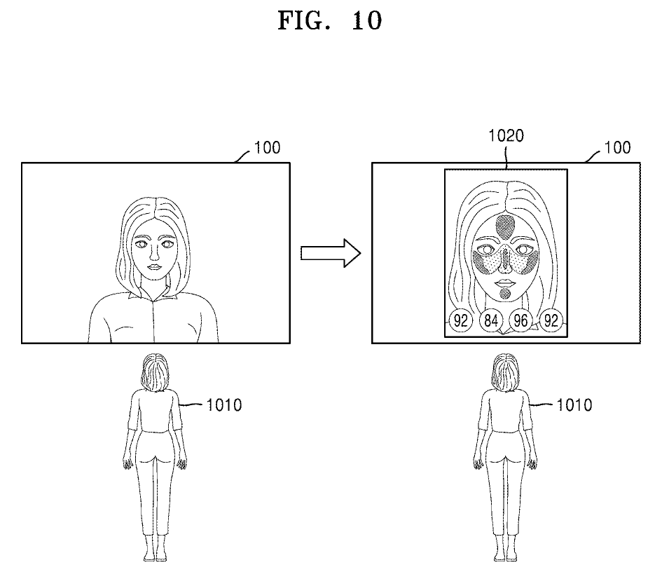

FIG. 10 is a diagram showing an operation in which a display device according to an embodiment of the disclosure analyzes and displays a user′s facial condition.

Referring to FIG. 10, a display device according to an embodiment of the disclosure may operate the panel as a mirror. As the method of operating, by the display device 100, the panel as a mirror is described in detail with reference to FIGS. 6 to 9, a detailed description thereof is omitted.

The display device 100 according to an embodiment of the disclosure may obtain a user′s face image through a camera while concurrently operating as a mirror. The display device 100 may analyze the user′s facial condition based on the user′s face image. For example, the display device 100 may align the position and direction of a face in the user's face image by applying a face recognition and facial alignment algorithm. The display device 100 may analyze a user's skin condition by applying an artificial intelligence model to the user's face image. For example, the display device 100 may analyze wrinkles, blemishes, pores, pigmentation, oil, moisture, or elasticity, and divide the user′s face into a plurality of regions to obtain an analysis result for each region.

As illustrated in FIG. 10, the display device 100 may display an analysis result 1020. In this state, the display device 100 may operate the panel as a display. The display device 100 may display analysis results by regions of the face (e.g., forehead, under the eyes, cheeks, or chin) and may display colors based on the analysis results by overlaying the color on the corresponding region. Accordingly, the display device 100 may intuitively provide users with the status of wrinkles, pigmentation, or pores of each region of the face.

Furthermore, the display device 100 may display text information or scores according to the analysis results at the bottom of the display or near the region, and thus, the user may numerically identify the state of each region. However, the disclosure is not limited thereto.

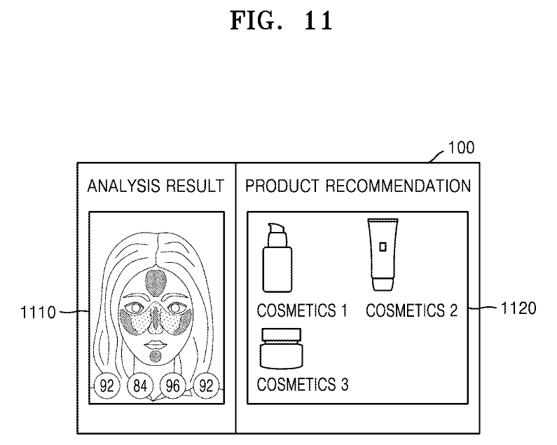

FIG. 11 is a diagram showing an example in which a display device according to an embodiment of the disclosure provides recommendation information based on the facial condition analysis.

Referring to FIG. 11, the display device 100 according to an embodiment of the disclosure may analyze a user′s facial condition and display an analysis result 1110. As the method in which the display device 100 analyzes the facial condition and displays the analysis result 1110 is described in detail with reference to FIG. 10, a detailed description thereof is omitted.

The display device 100 according to an embodiment of the disclosure may recommend user customized products based on the analysis result.

The display device 100 may display the analysis result 1110 of the facial condition in a first area of the panel, and display a recommendation product information 1120 according to the analysis result in a second area. As illustrated in FIG. 11, the recommendation product information 1120 may include cosmetics 1, cosmetics 2, and cosmetics 3. The display device 100 may receive an input of selecting recommended cosmetics and display detailed information on selected recommendation cosmetics. Alternatively, the display device 100 may display to a purchase page where the selected recommendation cosmetics can be purchased. However, the disclosure is not limited thereto.

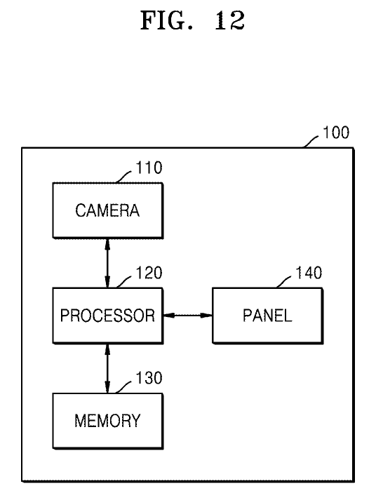

FIG. 12 is a block diagram of a display device according to an embodiment of the disclosure.

Referring to FIG. 12, the display device 100 according to an embodiment of the disclosure may include a camera 110, a processor 120, a memory 130, and a panel 140.

The camera 110 according to an embodiment of the disclosure may obtain an image frame, such as a still image or a video. For example, the camera 110 may capture an external image of the display device 100. In this state, the image captured by the camera 110 may be processed by the processor 120 or a separate image processor.

The camera 110 according to an embodiment of the disclosure may be arranged in a front surface portion of the display device 100, for example, in a bezel area of an upper end of a screen. The camera 110 is arranged to face a user located in front of the display device 100 so as to obtain an image captured of a user.

For example, the camera 110 may obtain an image (e.g., consecutive frames) corresponding to the user′s face in a camera recognition range. The processor 120 according to an embodiment of the disclosure may obtain a gaze direction of a user

information based on the image captured of a user. As the method of obtaining the information on the gaze direction of a user is described in detail with reference to FIGS. 2 and 3, a detailed description thereof is omitted.

The processor 120 according to an embodiment of the disclosure may control the overall operation of the display device 100 and a signal flow between internal components of the display device 100, and performs a function for processing data.

The processor 120 may include a single core, a dual core, a triple core, a quad core, or a multiple core thereof. Furthermore, the processor 120 may include a plurality of processors. For example, the processor 120 may implement a main processor (not shown) and a sub-processor (not shown).

Furthermore, the processor 120 may be configured as a hardware component that performs arithmetic, logic, input/output operations, and signal processing. The processor 120 may be configured as at least one of, for example, a central processing unit (CPU), a microprocessor, a graphics processing unit (GPU), a video processing unit (VPU), an application specific integrated circuit (ASIC), a digital signal processor (DSP), a digital signal processing device (DSPD), a programmable logic device (PLD), a field programmable gate array (FPGA), an application processor (AP), a neural processing unit (NPU), or an artificial intelligence processor designed with a hardware structure specialized for processing artificial intelligence models, but the disclosure is not limited thereto. Alternatively, according to an embodiment of the disclosure, the processor 120 may be implemented in the form of a system-on-chip (SoC) incorporating at least one of the above-listed processors.

The memory 130 according to an embodiment of the disclosure may include, for example, a non-volatile memory including at least one of a flash memory type, a hard disk type, a multimedia card micro type, a card type memory (e.g., SD or XD memory, etc.), read-only memory (ROM), and electrically erasable programmable read-only memory (EEPROM), or programmable read-only memory (PROM), and a volatile memory such as random access memory (RAM) or static random access memory (SRAM).

The memory 130 according to an embodiment of the disclosure may store various pieces of data, programs, or applications to drive and control the display device 100.

Furthermore, the programs stored in the memory 130 may include one or more instructions. The programs (one or more instructions) or applications stored in the memory 130 may be executed by the processor 120.

The processor 120 according to an embodiment of the disclosure may include one or more processors. When the processor 120 includes one or more processors, the operations of the disclosure may be performed by one or more processors individually or collectively executing the instructions and/or programs stored in the memory 130.

When a method according to an embodiment of the disclosure includes a plurality of operations, the plurality of operations may performed by one processor 120 or by a plurality of processors 120. For example, when a first operation, a second operation, and a third operation are performed by the method according to an embodiment of the disclosure, the first operation, the second operation, and the third operation may be all performed by a first processor, or the first operation and the second operation may be performed by the first processor while the third operation may be performed by a second processor.

One or more processors according to an embodiment of the disclosure may be implemented by a single-core processor or by a multi core processor. When the method according to an embodiment of the disclosure includes a plurality of operations, the plurality of operations may be performed by one core or by a plurality of cores included in the one or more processors.

The processor 120 according to an embodiment of the disclosure individually or collectively executes the one or more instructions stored in the memory 130 to control the camera 110 to capture an image of the user.

The processor 120 according to an embodiment of the disclosure individually or collectively executes the one or more instructions stored in the memory 130 to obtain the information on the position of the user. For example, the processor 120 may calculate the distance between the display device 100 and the user, based on sensor data collected from a camera or various sensors including an ultrasound sensor, an infrared sensor, or an RF-based sensor. Furthermore, the processor 120 may calculate a direction or an angle at which the user is positioned with respect to the display device 100, based on the sensor data. However, the disclosure is not limited thereto.

The processor 120 according to an embodiment of the disclosure individually or collectively executes the one or more instructions stored in the memory 130 to obtain information on the gaze direction of the user based on the user image.

For example, the processor 120 may track user′s gaze based on the user image. The processor 120 may recognize a user′s face from the user image captured of a user. The processor 120 may identify the outline of the face and key feature points, such as eyes, nose, or mouth, from the user image, by using a deep learning-based face recognition algorithm or a feature point-based algorithm. When a face is recognized, the processor 120 may delicately and accurately extract an eye area within a face area.

The processor 120 may identify positions of iris and pupil within the eye area and calculate a gaze direction in which a user views, based on the positions of the iris and the pupil. Furthermore, the processor 120 may calculate the gaze direction of a user by calculating a relative positional relationship between the center point of the pupil and the eye outline. The processor 120 may calculate a user′s head direction by using the key feature points (feature points, such as eye, nose, or mouth) of a face, and when calculating the gaze direction, may use information on the user′s head direction. However, the disclosure is not limited thereto.

The processor 120 according to an embodiment of the disclosure individually or collectively executes the one or more instructions stored in the memory 130 to operate at least a partial area of the panel as a mirror or a display, based on the information on the position of the user and the information on the gaze direction of the user.

For example, when the distance between the display device 100 and a user is greater than or equal to a preset distance, the processor 120 may operate the panel included in the display device 100 as a display, thereby displaying various pieces of information. Alternatively, when the distance between the display device 100 and a user is less than the preset distance, and the gaze direction of the user is directed toward a user reflected from the panel, the processor 120 may operate at least a partial area of the panel as a mirror. However, the disclosure is not limited thereto.

When a plurality of users are recognized, the processor 120 according to an embodiment of the disclosure individually or collectively executes the one or more instructions stored in the memory 130 to determine whether to operate the panel as a display or as a mirror, based on information on the position and gaze direction of a user positioned at the nearest distance from the display device 100.

When the panel is determined to operate as a mirror, the processor 120 according to an embodiment of the disclosure individually or collectively executes the one or more instructions stored in the memory 130 to operate only a part of the panel as a mirror according to the position of the user.

The panel 140 according to an embodiment of the disclosure may be switched between a mirror mode and a display mode and may operate in the mirror mode or the display mode. The panel 140 according to an embodiment of the disclosure may be formed as one integral module or in a structure in which a plurality of layers are stacked. For example, the panel 140 may include a mirror layer and a display layer.

The mirror layer may be a layer that operates as an ordinary mirror by reflecting external light. The mirror layer may include a half mirror or a switchable mirror. The half mirror, as a mirror that partially reflects light and partially transmit light, may be referred to as a translucent mirror. Furthermore, the switchable mirror may have transparency or reflectance that varies by an external electrical signal. For example, when power is off, the switchable mirror reflects light like a mirror, and when power in on, the switchable mirror may be switched to appear as transparent glass.

The display layer may be arranged at the rear side of the mirror layer and may include an OLED, a micro-LED, or a transparent display.

The panel 140 according to an embodiment of the disclosure may generate an electrical signal to adjust reflectance or transmittance of a mirror layer and apply the generated signal to the mirror layer. Accordingly, the panel 140 may operate in a mirror mode or a display mode. The panel 140 may convert an image signal, a data signal, an OSD signal, or a control signal, which is processed in the processor 120, to generate a driving signal for the display layer.

Furthermore, in the panel 140, only a partial area may operate in a mirror mode, and the other area may operate in a display mode.

Furthermore, it is possible to configure the panel 140 as a touch screen to be used as an input device other than an output device.

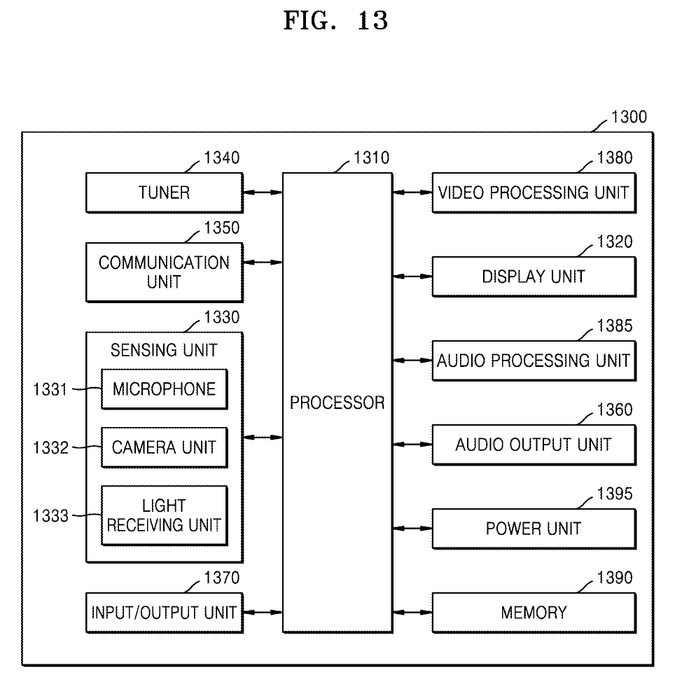

FIG. 13 is a block diagram of a display device 1300 according to an embodiment of the disclosure.

The display device 1300 of FIG. 13 may correspond to the display device 100 according to an embodiment of the disclosure described with reference to FIGS. 1 to 12.

Referring to FIG. 13, the display device 1300 according to an embodiment of the disclosure may include a tuner portion 1340, a processor 1310, a display unit 1320, a communication unit 1350, a sensing unit 1330, an input/output unit 1370, a video processing unit 1380, an audio processing unit 1385, an audio output unit 1360, a memory 1390, and a power unit 1395.

A camera unit 1332 of FIG. 13 may correspond to the camera 110 of FIG. 12, a processor 1310 of FIG. 13 may correspond to the processor 120 of FIG. 12, the memory 1390 of FIG. 13 may correspond to the memory 130 of FIG. 12, and the display unit 1320 of FIG. 13 may correspond to the panel 140 of FIG. 12. Accordingly, the same contents as those described above are omitted.

The tuner portion 1340 according to an embodiment of the disclosure may tune and select only the frequency of a channel to be received by the display device 1300 among many radio wave components, through amplification, mixing, or resonance of broadcast signals received in a wired or wireless manner. The broadcast signal may include audio, video, and additional information (e.g., electronic program guide (EPG)).

The tuner portion 1340 may receive a broadcast signal from various sources, such as terrestrial broadcast, cable broadcast, satellite broadcast, or Internet broadcast. The tuner portion 1340 may receive a broadcast signal from a source such as analog broadcast or digital broadcast.

The communication unit 1350 may transceive data or signals with an external device.

The communication unit 1350 according to an embodiment of the disclosure may transceive data or signals with an external device or a server. For example, the communication unit 1350 may perform communication with an external device through a wired or wireless communication network. The communication unit 1350 may include at least one port connected by a cable for wired communication with an external device. For example, the communication unit 1350 may include at least one of a high-definition

multimedia interface (HDMI) port, a mobile high-definition link (MHL) port, a universal serial bus (USB) port, a display port (DP), a thunderbolt port, a video graphics array (VGA) port, an RGB port, a D-subminiature (D-SUB), a digital visual interface (DVI), a component jack, a PC port. The communication unit 1350 may perform communication with an external device connected via wires through at least one port.

Furthermore, the communication unit 1350 may include a Wi-Fi module, a Bluetooth module, an infrared communication module, a wireless communication module, a LAN module, or an Ethernet module. In this state, each communication module may be implemented in the form of at least one hardware chip.

The Wi-Fi module and the Bluetooth module perform communication in a Wi-Fi method and a Bluetooth method, respectively. When the Wi-Fi module or the Bluetooth module is used, various pieces of connection information such as SSID or a session key are first transceived, and a communication is established by using the connection information and then various pieces of information may be transceived. The wireless communication module may include at least one communication chip that performs communication according to various wireless communication protocols, such as Zigbee, 3rd generation (3G), 3G partnership project (3GPP), long term evolution (LTE), LTE advanced (LTE-A), 4th generation (4G), or 5th generation (5G).

The communication unit 1350 according to an embodiment of the disclosure may receive a control signal or a control command corresponding to a user input (e.g., a key or button input of a control device, etc.) from the control device.

The sensing unit 1330 according to an embodiment of the disclosure may detect a user's voice, a user's image, or a user's interaction, and include a microphone 1331, the camera unit 1332, and a light receiving unit 1333.

The microphone 1331 may receive voice uttered by a user. The microphone 1331 may convert the received voice into an electrical signal to output the converted signal to the processor 1310. The user's voice may include, for example, a voice corresponding to a menu or function of the display device 1300. For example, the microphone 1331 may receive the user's voice corresponding to a display rotation command, and convert the received voice into an electrical signal to output the converted signal to the processor 1310.

The camera unit 1332 may receive an image (e.g., consecutive frames) corresponding to user's motion including a gesture in the camera recognition range. The processor 1310 may use a recognition result of the received motion to select a menu displayed on the display device 1300 or perform a control corresponding to the motion recognition result.

The light receiving unit 1333 may receive an optical signal (including a control signal) received from an external control device through a light window (not shown) of the bezel of the display unit 1320. The light receiving unit 1333 may receive an optical signal corresponding to a user input (e.g., touch, press, touch gesture, voice, or motion) from the control device. The control signal may be extracted from the received optical signal under the control of the processor 1310.

The input/output unit 1370 according to an embodiment of the disclosure may receive, from the outside of the display device 1300, a video (e.g., a motion picture, etc.), audio (e.g., voice, music, etc.), and additional information (e.g., EPG, etc.). The input/output unit 1370 may include any one of HDMI, MHL, USB, DP, thunderbolt, a VGA port, an RGB port, D-SUB, DVI, a component jack, or a PC port.

The processor 1310 may control the overall operation of the display device 1300 and a signal flow between the internal components of the display device 1300, and perform a function for processing data. When a user's input exists or a preset and stored condition is satisfied, the processor 1310 may execute operating system (OS) and various applications stored in the memory 1390.

The processor 1310 may include RAM that stores a signal or data input from the outside of the display device 1300 or is used as a storage area corresponding to various works performed in the display device 1300, ROM that stores a control program for control of the display device 1300, and a processor.

The video processing unit 1380 performs processing on the video data received by the display device 1300. The video processing unit 1380 may perform various image processes, such as decoding, scaling, noise filtering, framerate conversion, or resolution conversion on the video data.

The audio processing unit 1385 may perform audio data processing. The audio processing unit 1385 may perform various processes, such as decoding, amplification, or noise filtering, on audio data. The audio processing unit 1385 may include a plurality of audio processing modules to process audio corresponding to a plurality of contents.

The audio output unit 1360 may output audio including in the broadcast signal received through the tuner portion 1340, under the control of the processor 1310. The audio output unit 1360 may output audio (e.g., voice or sound) input through the communication unit 1350 or the input/output unit 1370. Furthermore, the audio output unit 1360 may output audio stored in the memory 1390 under the control of the processor 1310. The audio output unit 1360 may include at least one of a speaker, a headphone output terminal, a Sony/Philips digital interface (S/PDIF), or an output terminal.

The power unit 1395 supplies power input from an external power source to the components in the display device 1300, under the control of the processor 1310. Furthermore, the power unit 1395 supplies power output from one or two or more batteries (not shown) positioned inside the display device 1300, under the control of the processor 1310.

The memory 1390 may store various pieces of data, programs, or applications to drive and control the display device 1300, under the control of the processor 1310. The memory 1390 may include a broadcast receiving module, a channel control module, a volume control module, a communication control module, a voice recognition module, a motion recognition module, a light receiving module, a display control module, an audio control module, an external input control module, a power control module, a power control module of an external device that is wirelessly connected (e.g., Bluetooth) manner, a voice database (DB), or a motion DB, which are not shown. The modules and database of the memory 1390, which are not illustrated, may be implemented in a software form to perform a broadcast reception control function, a channel control function, a volume control function, a communication control function, a voice recognition function, a motion recognition function, a light receiving control function, a display control function, an audio control function, an external input control function, a power control function, or a power control function of an external device that is connected wirelessly (e.g., Bluetooth) in the display device 1300. The processor 1310 may perform each function by using software stored in the memory 1390.

The block diagrams of the display devices 100 and 1300 illustrated in FIGS. 12 and 13 are block diagrams for an embodiment of the disclosure. Each component of the block diagrams may be incorporated, added, or omitted according to the specifications of the display devices 100 and 1300 that are actually implemented. In other words, as necessary, two or more components may be incorporated into one component, or one component may be divided into two or more components. Furthermore, a function performed by each block is provided to describe an embodiment of the disclosures, and a specific operation or device does not limit the right scope of the disclosure.

A display device according to an embodiment of the disclosure may include a camera, a panel including at least a partial area that operates as a mirror or a display, memory storing one or more instructions, and at least one processor including processing circuitry.

The one or more instructions, when executed by the at least one processor according to an embodiment of the disclosure individually or collectively, may cause the display device to control the camera to capture an image of a user to obtain a user image.

The one or more instructions, when executed by the at least one processor according to an embodiment of the disclosure individually or collectively, may cause the display device to obtain information on the position of the user.

The one or more instructions, when executed by the at least one processor according to an embodiment of the disclosure individually or collectively, may cause the display device to obtain information on a gaze direction of the user based on the user image.

The one or more instructions, when executed by the at least one processor according to an embodiment of the disclosure individually or collectively, may cause the display device to control, based on the position information and the information on the gaze direction of the user, the panel such that the at least a partial area of the panel operates as a mirror or a display.

The information on the position of the user according to an embodiment of the disclosure may include information on a distance between the user and the panel.

The one or more instructions, when executed by the at least one processor according to an embodiment of the disclosure individually or collectively, may cause the display device to control the panel 140 to operate as a display, based on the distance being greater than or equal to a preset distance.

When the one or more instructions, when executed by the at least one processor according to an embodiment of the disclosure individually or collectively, may cause the display device to obtain information on the gaze direction of a user, based on the distance being less than the preset distance.

The one or more instructions, when executed by the at least one processor according to an embodiment of the disclosure individually or collectively, may cause the display device to identify whether the gaze direction of the user is directed toward the user image reflected on the panel.

The one or more instructions, when executed by the at least one processor according to an embodiment of the disclosure individually or collectively, may cause the display device to control, based on identifying that the gaze direction of the user is directed toward the user image reflected on the panel, the panel such that the at least a partial area of the panel operates as a mirror.

The one or more instructions, when executed by the at least one processor according to an embodiment of the disclosure individually or collectively, may cause the display device to control the panel, based on the information on the position of the user, such that only a partial area of the panel corresponding to the position of the user operates as a mirror, and the other area of the panel operates as a display.

The one or more instructions, when executed by the at least one processor according to an embodiment of the disclosure individually or collectively, may cause the display device to capture, based on a plurality of users being recognized, an image of a first user positioned at the nearest distance from the display device, among the plurality of users, to obtain the user image.

The panel according to an embodiment of the disclosure may include a plurality of areas.

The one or more instructions, when executed by the at least one processor according to an embodiment of the disclosure individually or collectively, may cause the display device to control, based on the position information and the gaze information of the first user corresponding to a first area of the plurality of areas, the panel such that the first area of the plurality of areas operates as a display.

The one or more instructions, when executed by the at least one processor according to an embodiment of the disclosure individually or collectively, may cause the display device to control, based on the position information and the gaze information of a second user corresponding to a second area of the plurality of areas, the panel such that the second area of the plurality of areas operates as a mirror.

The one or more instructions, when executed by the at least one processor according to an embodiment of the disclosure individually or collectively, may cause the display device to control the camera to capture an image of a user′s face, based on the panel operating as a mirror.

The one or more instructions, when executed by the at least one processor according to an embodiment of the disclosure individually or collectively, may cause the display device to analyze a user′s facial condition, based on the image of the user′s face.

The one or more instructions, when executed by the at least one processor according to an embodiment of the disclosure individually or collectively, may cause the display device to operate the panel as a display to display a facial condition analysis result.

The one or more instructions, when executed by the at least one processor according to an embodiment of the disclosure individually or collectively, may cause the display device to operate, based on the facial condition analysis result, the panel as a display to display recommended products.

The panel according to an embodiment of the disclosure may include at least one of a switchable mirror, a half mirror, and an OLED display mirror.

An operating method of a display device, according to an embodiment of the disclosure, may include capturing an image of a user to obtain a user image.

The operating method of a display device, according to an embodiment of the disclosure, may include obtaining information on the position of the user.

The operating method of a display device, according to an embodiment of the disclosure, may include obtaining information on the gaze direction of the user, based on the user image.

The operating method of a display device, according to an embodiment of the disclosure, may include operating at least a partial area of a panel as a mirror or a display, based on the position information and the information on the gaze direction of the user.

The information on the position of the user according to an embodiment of the disclosure may include information on a distance between the user and the panel.

The operating of the at least a partial area of the panel according to an embodiment of the disclosure as a mirror or a display may include operating the panel as a display, based on the distance being greater than or equal to a preset distance.

The obtaining of the information on the gaze direction of the user according to an embodiment of the disclosure may include obtaining information on the gaze direction of the user, based on the distance being less than the preset distance.

The obtaining of the information on the gaze direction of the user according to an embodiment of the disclosure may include identifying whether the gaze direction of the user is directed toward the user image reflected on the panel.

The operating of the at least a partial area of the panel according to an embodiment of the disclosure as a mirror or a display may include operating at least a partial area of the panel as a mirror, based on identifying that the gaze direction of the user is directed toward the user image reflected on the panel.

The operating of the at least a partial area of the panel according to an embodiment of the disclosure as a mirror may include operating only a partial area of the panel corresponding to the position of the user as a mirror, and operating the other area of the panel as a display, based on the information on the position of the user.

The capturing of the image of the user to obtain the user image according to an embodiment of the disclosure may include, based on a plurality of users being recognized, capturing an image of a first user positioned at the nearest distance from the display device, among the plurality of users, to obtain the user image.

The panel according to an embodiment of the disclosure may include a plurality of areas.

The operating of the at least a partial area of the panel according to an embodiment of the disclosure as a mirror or a display may include operating a first area of the plurality of areas as a display, based on the position information and the gaze information of the first user corresponding to the first area of the plurality of areas.

The operating of the at least a partial area of the panel according to an embodiment of the disclosure as a mirror or a display may include operating a second area of the plurality of areas as a mirror, based on the position information and the gaze information of a second user corresponding to the second area of the plurality of areas.

The operating method of a display device, according to an embodiment of the disclosure, may include capturing an image of a user′s face to obtain a user′s face image, based on the panel operating as a mirror.

The operating method of a display device, according to an embodiment of the disclosure, may include analyzing a user′s facial condition, based on the image of the user′s face.

The operating method of a display device, according to an embodiment of the disclosure, may include operating the panel as a display to display a facial condition analysis result.

The operating method of a display device, according to an embodiment of the disclosure, may include operating, based on the facial condition analysis result, the panel as a display to display recommended products.

The display device according to an embodiment of the disclosure is switchable to a mirror mode or a display mode, thereby providing various functions.

The display device according to an embodiment of the disclosure may determine the intention of a user without an additional command or input from the user, and may automatically switch to a mirror mode or a display mode, thereby improving the user's convenience of use.

The display device according to an embodiment of the disclosure may switch only a partial area, rather than an entire panel, to a mirror mode or a display mode, thereby enabling various uses of the display device.

The operating method of a display device, according to an embodiment of the disclosure, may be embodied as program instructions executable by various computer devices, and recorded on a computer-readable medium. The computer-readable medium may include program instructions, data files, data structures, or the like separately or in combinations. The program instructions to be recorded on the medium may be specially designed and configured for the disclosure or may be well-known to and be usable by those skill in the art of computer software. Examples of the computer-readable recording medium include magnetic media such as hard disks, floppy disks, or magnetic tapes, optical media such as compact disc ROMs (CD-ROMs) or digital video discs (DVDs), magneto-optical media such as floptical disks, and hardware devices such as ROM, RAM, and flash memory, which are specially configured to store and execute program instructions. An example of a program command may include not only machine codes created by a compiler, but also high-level programming language executable by a computer using an interpreter.

Furthermore, the operating method of a display device, according to an embodiment of the disclosures may be provided by being included in a computer program product. A computer program product as goods may be dealt between a seller and a buyer.

A computer program product may include a S/W program and a computer-readable storage medium where the S/W program is stored. For example, a computer program product may include a product in the form of a S/W program, for example, a downloadable application, that is electronically distributed through a manufacturer of an electronic device or an electronic market, for example, an application store. For electronic distribution, at least part of a S/W program may be stored in a storage medium or temporarily generated. In this case, a storage medium may be a manufacturer's server, an electronic market's server, or a storage medium of a relay server that temporarily stores a SW program.

A computer program product may include a server's storage medium or a client device's storage medium in a system including a server and a client device. Alternatively, when there is a third device (e.g., a smartphone) communicatively connected to a server or a client device, the computer program product may include a storage medium of the third device. Alternatively, a computer program product may include a S/W program that is transmitted from a server to a client device or a third device, or from the third device to the client device.

In this case, any one of the server, the client device, and the third device may perform a method according to the disclosed embodiments by executing the computer program product. Alternatively, two or more of the server, the client device, and the third device may perform, in a distribution manner, the method according to the disclosed embodiments by executing the computer program product.

For example, a server (e.g., a cloud server or an artificial intelligent server) executes a computer program product stored in the server, so that the client device communicatively connected to the server may be controlled to perform the method according to the disclosed embodiments.

Although embodiments have been described above in detail, the scope of the disclosure is not limited thereto, and various modifications and alterations by those skill in the art using the basic concept of the disclosure defined in the following claims also fall within the scope of the disclosure.

1. A display device comprising:
a camera;
a panel including at least a partial area that is operable as a mirror and operable as a display;
at least one processor including processing circuitry; and
memory storing one or more instructions that, when executed by the at least one processor individually or collectively, cause the display device to:
control the camera to capture an image of a user to obtain a user image,
obtain information on a position of the user,
obtain information on a gaze direction of the user based on the user image, and
control, based on the information on the position of the user and the information on the gaze direction of the user, the panel such that the at least a partial area of the panel operates as at least one of the mirror and the display.

2. The display device of claim 1, wherein
the information on the position of the user includes information on a distance between the user and the panel, and
the one or more instructions, when executed by the at least one processor individually or collectively, cause the display device to control the panel to: operate as the display based on the distance being greater than or equal to a preset distance.

3. The display device of claim 2, wherein the one or more instructions, when executed by the at least one processor individually or collectively, cause the display device to:
obtain information on the gaze direction of the user based on the distance being less than the preset distance, and
identify whether the gaze direction of the user is directed toward the user image reflected on the panel.

4. The display device of claim 3, wherein the one or more instructions, when executed by the at least one processor individually or collectively, cause the display device to:
control, based on identifying that the gaze direction of the user is directed toward the user image reflected on the panel, the panel such that the at least a partial area of the panel operates as the mirror.

5. The display device of claim 4, wherein the one or more instructions, when executed by the at least one processor individually or collectively, cause the display device to:
control, based on the information on the position of the user, the panel such that a portion of the at least a partial area of the panel corresponding to the position of the user operates as the mirror and another portion of the at least a partial area of the panel operates as the display.

6. The display device of claim 1, wherein the one or more instructions, when executed by the at least one processor individually or collectively, cause the display device to:
based on a plurality of users being recognized, capture an image of a first user positioned at a nearest distance from the display device, among the plurality of users, as the user image.

7. The display device of claim 1, wherein the panel includes a plurality of areas, and
the one or more instructions, when executed by the at least one processor individually or collectively, cause the display device to:
control, based on information on the position and the gaze direction of a first user corresponding to a first area of the plurality of areas, the panel such that the first area of the plurality of areas operates as the display, and
control, based on information on the position and the gaze direction of a second user corresponding to a second area of the plurality of areas, the panel such that the second area of the plurality of areas operates as the mirror.

8. The display device of claim 1, wherein the one or more instructions, when executed by the at least one processor individually or collectively, cause the display device to:
control the camera to capture an image of a user′s face based on the panel operating as the mirror,
analyze a user′s facial condition based on the image of the user′s face, and
operate the at least a partial area of the panel as the display to display a facial condition analysis result.

9. The display device of claim 8, wherein the one or more instructions, when executed by the at least one processor individually or collectively, cause the display device to:
operate, based on the facial condition analysis result, the at least a partial area of the panel as the display to display recommended products.

10. The display device of claim 1, wherein the panel includes at least one of a switchable mirror, a half mirror, and an organic light-emitting diode (OLED) display mirror.

11. An operating method of a display device including a panel having at least a partial area that is operable as a mirror and operable as a display, the operating method comprising:
capturing an image of a user to obtain a user image;
obtaining information on a position of the user;
obtaining information on a gaze direction of the user based on the user image; and
operating the at least a partial area of the panel as at least one of the mirror and the display based on the information on the position of the user and the information on the gaze direction of the user.

12. The operating method of claim 11, wherein
the information on the position of the user includes information on a distance between the user and the panel, and
the operating the at least a partial area of the panel includes:
operating the at least a partial area of the panel as the display based on the distance being greater than or equal to a preset distance.

13. The operating method of claim 12, wherein the obtaining the information on the gaze direction of the user includes:
obtaining information on the gaze direction of the user based on the distance being less than the preset distance, and
identifying whether the gaze direction of the user is directed toward the user image reflected on the panel.

14. The operating method of claim 13, wherein the operating the at least a partial area of the panel includes:
operating the at least a partial area of the panel as the mirror based on identifying that the gaze direction of the user is directed toward the user image reflected on the panel.

15. The operating method of claim 14, wherein the operating the at least a partial area of the panel includes:
based on the information on the position of the user, operating a portion of the at least a partial area of the panel corresponding to the position of the user as the mirror and operating another portion of the at least a partial area of the panel as the display.

16. The operating method of claim 11, wherein the capturing the image of the user to obtain the user image includes:
based on a plurality of users being recognized, capturing an image of a first user positioned at a nearest distance from the display device, among a plurality of users, as the user image.

17. The operating method of claim 11, wherein the panel includes a plurality of areas, and
the operating the at least a partial area of the panel includes:
operating a first area of the plurality of areas as the display based on the information on the position and the information on the gaze direction of a first user corresponding to the first area of the plurality of areas, and
operating a second area of the plurality of areas as the mirror based on the information on the position and the information on the gaze direction of a second user corresponding to the second area of the plurality of areas.

18. The operating method of claim 11, further comprising:
capturing an image of a user′s face to obtain a user′s face image based on the panel operating as the mirror;
analyzing a user′s facial condition based on the image of the user′s face; and
operating the at least a partial area of the panel as the display to display a facial condition analysis result.

19. The operating method of claim 18, further comprising:
operating, based on the facial condition analysis result, the at least a partial area of the panel as the display to display recommended products.

20. A non-transitory computer-readable medium storing a program for executing the operating method according to claim 11.
